(19) United States
(12) Patent Application Publication
(10) Pub. No.: US 2025/0192554 A1
(43) Pub. Date: Jun. 12, 2025

(54) METHODS AND DEVICES FOR MANAGING LOAD SHEDDING IN A RESOURCE DISTRIBUTION NETWORK

(71) Applicant: SAGEMCOM ENERGY & TELECOM SAS, BOIS-COLOMBES (FR)

(72) Inventor: Henri TEBOULLE, BOIS-COLOMBES (FR)

(21) Appl. No.: 18/970,881

(22) Filed: Dec. 5, 2024

(30) Foreign Application Priority Data
Dec. 7, 2023 (FR) 2313719

(51) Int. Cl. H02J 3/14; H02J 3/00; H02J 13/00

(52) U.S. Cl. CPC H02J 3/144; H02J 3/003; H02J 13/00002

(57) ABSTRACT

Load shedding is implemented in a resource distribution network to avoid overconsumption. The network comprises at least one network head and a plurality of meters configured to measure consumption of said resource by a customer and to transmit to the network head customer information representative of the customer's consumption over a given time range. Based on the customer information transmitted by the meters, a overall forecast consumption is determined for all meters for the specified time period. One or more load-shedding periods are determined by comparing the overall forecast consumption with a predefined overall threshold. For each one, the meters to be load-shed are selected according to the expected load-shedding gains for the eligible meters. Furthermore, a load-shedding command is sent to them, concerning one or more future occurrences within the specified time range.

### CROSS-REFERENCE TO RELATED APPLICATIONS

The present application claims priority to French Application No. 2313719 filed with French National Institute of Industrial Property (INPI) on Dec. 7, 2023, which is incorporated herein by reference in its entirety for all purposes.

### TECHNICAL FIELD

The various example embodiments described in the present disclosure relate to load shedding in a resource distribution network, for example a distribution network for electricity, gas, heat, etc., in order to control demand and avoid overconsumption which could lead to a collapse of the distribution network.

### BACKGROUND

Document US2022/0376504A1 discloses a load-shedding method in an electrical network triggered after detecting an event leading to insufficient power generation in the network.

There is a need for a method of managing load shedding in a distribution network that responds to variations in demand.

### SUMMARY

A first aspect of the present disclosure relates to a method for managing load shedding in a resource distribution network, the network comprising at least one network head and a plurality of meters configured to measure a consumption of said resource by a customer, transmit to the network head information representative of the customer's consumption, receive a load-shedding command from the network head and trigger a switch from a non-load-shedding operating mode to a load-shedding operating mode based on said command. This load-shedding management method further comprises steps for determining, from information representative of the customer's consumption, an overall forecast consumption over a time range for all the meters; determining one or more load-shedding periods for said time range, by comparing the overall forecast consumption with a predefined overall threshold; determining one or more meters eligible for load-shedding, for the load-shedding period(s), by comparing information representative of the customer's consumption over the load-shedding period with a predefined customer threshold, selecting one or more meters to be load-shed from the meters eligible for load-shedding, to obtain a target gain making it possible to compensate for a difference between a maximum of the overall forecast consumption over the load-shedding period and the predefined overall threshold; sending a load-shedding command to the selected meters, said command relating to one or more future occurrences of said time range and specifying one or more load-shedding periods for said time range.

Advantageously, only information representative of the customer's consumption in non-load-shedding mode is taken into account to determine the overall forecast consumption and/or to determine which meters are eligible for load-shedding.

In a first embodiment, the load-shedding management method comprises a step for calculating a number of meters to be load-shed based on the ratio between the difference to be compensated and the predefined customer threshold, the selection of said number of meters to be load-shed from the eligible meters being made, for example, at random.

According to this first embodiment, the load-shedding command comprises, for example, a start and end indication, or a duration indication, for each load-shedding period for said time range. For example, the start indications transmitted to different meters for the same load-shedding period are offset in time from one another.

According to a second embodiment, the load-shedding management method comprises a step for determining a load-shedding gain for eligible meters, by comparing information representative of the customer's consumption in non-load-shedding mode, with information, learned during a learning phase, representative of the customer's consumption in load-shedding mode, and the selection of meters to be load-shed is based on said load-shedding gains.

For example, during the learning phase, for each time range considered, a load-shedding command is sent to each meter by time slot, in order to obtain information representative of the customer's consumption in load-shedding mode, for each time slot of each time range, the load-shedding periods being synchronized to said time slots.

For example, the selection of meters to be load-shed comprises determining a first number of meters greater than the number of meters required to achieve the target gain, and a random selection from a second number of meters, less than the first number, to achieve the target gain.

For example, the selection of meters to be load-shed comprises determining from the eligible meters taken in order of decreasing load-shedding gain, a first, second and third group comprising Q1, Q2 and Q3 eligible meters respectively, the sum of the load-shedding gains of the Q1+Q2 meters of the first and second groups allowing the target gain to be achieved, and the sum of the load-shedding gains of the Q2+Q3 meters of the second and third groups allowing the target gain to be achieved, then a selection from the Q1+Q2+Q3 eligible meters of Q2+Q3 meters to be load-shed.

In this second embodiment, the load-shedding command comprises, for example, a number of load-shedding periods for said time range and an identifier for each load-shedding period.

Also disclosed is a computer program product comprising instructions which when executed by at least one processor cause such a load-shedding management method to be implemented.

Also disclosed is a computer-readable storage medium comprising instructions which when executed by a processor cause such a load-shedding management method to be implemented. In one embodiment, the storage medium is non-transitory.

A second aspect of the present disclosure relates to a network head device which comprises means for implementing such a load-shedding management method in a distribution network.

A third aspect of the present disclosure relates to a load-shedding method by a meter belonging to a resource distribution network, the meter being configured to measure a consumption of said resource by a customer and to transmit, to a network head of the distribution network, customer information representative of the customer's consumption over a specified time range. The method further comprises a step of receiving a load-shedding command from the network head, the load-shedding command specifying one or more load-shedding periods to be implemented during one or more future occurrences of the specified time range.

In a first example, the load-shedding command comprises a start and end indication, or duration indication, for each load-shedding period. In a second example, the load-shedding command comprises a number of load-shedding periods for said time range and an identifier for each load-shedding period. Advantageously, load-shedding is initiated and/or terminated at a random time relative to the load-shedding periods specified in the load-shedding command.

Also disclosed is a computer program product comprising instructions which when executed by at least one processor cause such a load-shedding method to be implemented.

Also disclosed is a computer-readable storage medium comprising instructions which when executed by a processor cause such a load-shedding method to be implemented. In one embodiment, the storage medium is non-transitory.

A fourth aspect of the present disclosure relates to a metering device comprising means for implementing such a load-shedding method.

The network head and metering devices can consist of software means, that is, instructions intended to be executed by a set of circuits to perform one or more or all of the operations or steps to be carried out by the network head and/or the meter, in application of the methods described in the present disclosure. The circuit assembly may consist of dedicated circuitry. It may also consist of one or more processors and one or more memories comprising one or more computer program codes, said processors, memories and computer codes being configured to cause the network head and/or the meter to execute one or more or all of the steps of the methods described in the present disclosure.

### BRIEF DESCRIPTION OF THE FIGURES

The embodiments will be better understood in light of the following detailed description and the accompanying drawings, which are given by way of illustration only and therefore do not limit the present disclosure.

FIG. 1 is a diagram of an example of a distribution network.

FIG. 2 shows a plurality of customer load curves over a given time range.

FIG. 3 shows an overall forecast curve over the same specified time range.

FIG. 4 is a diagram describing the steps of a load-shedding management method intended for implementation in a network head of a distribution network.

FIG. 5 discloses the step for selecting the meters to be load-shed in a first embodiment.

FIG. 6 discloses the step for selecting the meters to be load-shed in a second embodiment.

FIG. 7 discloses a particular implementation of the step for selecting the meters to be load-shed in the second embodiment.

FIG. 8 gives the same load curves as FIG. 2, showing two load-shedding periods corresponding to two time slots of the specified time range.

FIG. 9 is a diagram describing the steps of a load-shedding method intended for implementation in a meter of a distribution network.

FIG. 10 is a block diagram of a device for implementing a network head or a meter according to the present disclosure.

### DETAILED DESCRIPTION

Various embodiments will now be described in more detail, by way of non-limiting examples, with reference to the drawings accompanying the present disclosure and illustrating certain exemplary embodiments.

The specific structural and functional details disclosed here are non-limiting examples. The embodiments disclosed here may undergo various modifications and alternative forms. The subject matter of the disclosure may be embodied in many different forms and should not be construed as being limited solely to the embodiments presented herein as illustrative examples. It should be understood that there is no intention to limit the embodiments to the particular forms described in the remainder of this document.

The present disclosure applies to any resource distribution network comprising at least one network head and a plurality of meters measuring the consumption of said resource. This could be for example a distribution network for electricity, gas, water, heat, etc. In the following, the distribution network which will be described is an electricity distribution network. This is a non-exhaustive illustrative example.

In the non-limiting example shown in FIG. 1, a distribution network 10 comprises at least one network head 11 which is intended to communicate via a sub-distributor 12 with a plurality of meters 13 which are installed on customer premises 14. For example, the network head 11 communicates with the sub-distributor 12 via a wireless telecoms network 15. The wireless communication network 15 can be a GPRS, UMTS, LTE, 5G or narrowband IoT (Internet-of-Things) network. For example, the sub-distributor 12 communicates with the meters 13 via the electrical network using power line communication (PLC).

A meter 13 installed on customer premises 14 is configured to measure a consumption by the customer 14 of the resource which is distributed via the distribution network 10. For example, when the network 10 is an electricity distribution network, the meter 13 measures the electricity consumption of the customer 14.

The meters 13 are also configured to transmit customer information to the network head 11, representative of the consumption by the customer 14 over a given period of time. For example, the meters 13 transmit information representative of daily consumption. This customer information comprises, for example, a consumption value per time slot of a given duration, for example every 15 minutes. The values transmitted for each 15-minute time slot during the day are used to establish a load curve for the customer for the day.

The network head 11 is configured to transmit load-shedding commands to one or more meters 13.

The meters 13 are configured to perform load shedding, in accordance with the load shedding commands they receive from the network head 11. For example, a meter 13 can perform load shedding by disconnecting one or more electricity-consuming elements on customer premises 14, for example a hot water tank and/or one or more radiators. This kind of load shedding reduces consumption and thus avoids the risk of the distribution network collapsing.

For example, data is exchanged between the meters 13 and the network head 11 using DLMS/COSEM-compliant data frames.

In the embodiments described below by way of example, a given time slot corresponds to a specific day of the week (i.e. Sunday, Monday, etc.). The network head 11 then separately stores customer information for each day of the week. In this way, differences in consumption profiles depending on the day of the week can be taken into account.

Other embodiments are possible, using other specified time ranges. For example, a given time range can correspond to any working day or any non-working day. In this case, the network head 11 stores both customer information for working days and customer information for non-working days. In another example, the specified time range corresponds to a specific week or month of the year. In this case, the network head 11 stores customer information for each individual week or month of the year. In this example, it is possible to take into account differences in consumption profiles according to vacation weeks or seasons of the year.

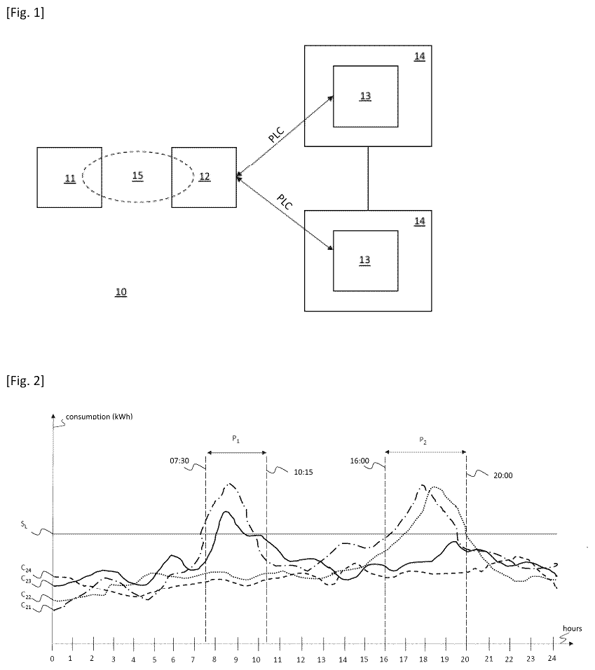

FIG. 2 shows the load curves of four customers C₂₁, C₂₂, C₂₃ and C₂₄ over a specified time range, which in this example corresponds to a given day of the week (day D). In this example, we assume that the day D for which customer information has been collected is a day without load shedding for customers C₂₁ to C₂₄. FIG. 2 shows a threshold S_{L}, known as the predefined customer threshold, which corresponds to a theoretical maximum consumption for a customer.

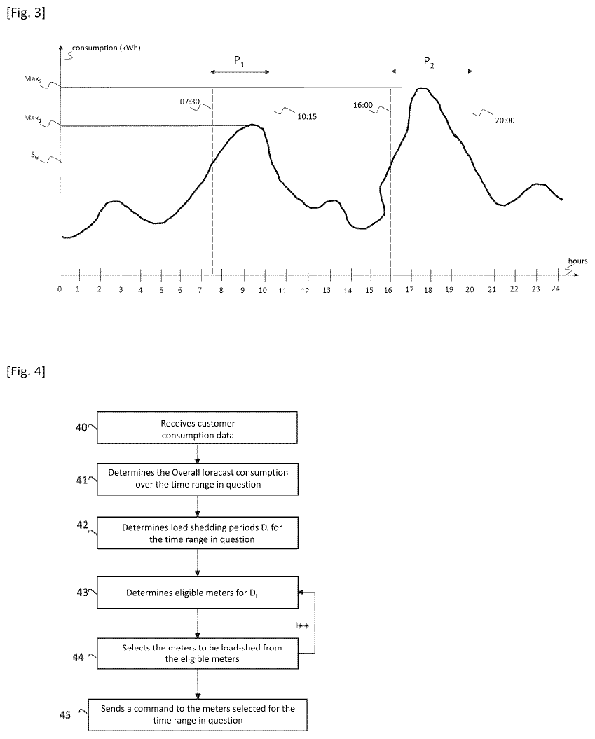

FIG. 3 shows a forecast curve representing overall forecast consumption, obtained for the same time range, i.e. for day D, from the load curves of the four customers shown in FIG. 2.

FIG. 3 shows a threshold S_{G}, known as the predefined overall threshold, which corresponds to a theoretical maximum consumption for all customers C₂₁ to C₂₄. FIG. 3 shows that the predefined overall threshold S_{G} is exceeded during two periods, known as overconsumption periods, P₁ between 07:30 and 10:15 and P₂ between 16:00 and 20:00. The maximum consumption during the period of overconsumption P₁ is denoted Max₁ and the maximum consumption during the period of overconsumption P₂ is denoted Max₂.

The periods of overconsumption P₁ and P₂ are shown in FIG. 2. We can then see that the customers who exceed the predefined customer threshold S_{L} during the overconsumption period P₁ are customers C₂₁ and C₂₃. And the customers who exceed the predefined customer threshold S_{L} during the overconsumption period P₂ are customers C₂₁ and C₂₂. In other words: customer C₂₁ exceeds the predefined customer threshold S_{L} during both periods of overconsumption P₁ and P₂; customer C₂₂ exceeds the predefined customer threshold S_{L} during the period of overconsumption P₂; customer C₂₃ exceeds the predefined customer threshold S_{L} during the period of overconsumption P₁; and customer C₂₄ never exceeds the predefined customer threshold S_{L}.

According to the embodiment, each period of overconsumption may give rise to one or more periods of load shedding. For example, a period of overconsumption may constitute a single load-shedding period or may correspond to a plurality of load-shedding periods.

FIG. 4 is a flowchart showing the main stages of a load-shedding management method to be implemented by the network head 11. In step 40, the network head 11 receives customer information representative of the customer's consumption over a specified time range (for example one day D of the week) from a plurality of meters in the distribution network. In step 41, the network head 11 uses the information representative of the customer's consumption to determine an overall forecast consumption over a time range for all the meters. In step 42, the network head 11 determines one or more Dᵢ load-shedding periods from the customer information received. In step 43, the network head 11 determines one or more meters eligible for load-shedding for each load-shedding period Dᵢ, by comparing the customer information for the load-shedding period with the predefined customer threshold S_{L}. In step 44, the network head 11 selects the meters to be load-shed from the eligible meters. In step 45, the network head 11 sends a load-shedding command to the selected meters for one or more future occurrences of the specified time range (for example for day D of the following week).

In the following description, two embodiments will be disclosed in detail by way of non-limiting examples.

In the first embodiment, the periods of overconsumption each consist of a single load-shedding period. Thus, taking the example described in FIG. 2 and FIG. 3, in step 42, the network head 11 determines two load-shedding periods Dᵢ=P₁ and D₂=P₂. And in step 43, it determines the eligible meters for each of the two periods Dᵢ and D₂ by comparing the customer consumption information over the load-shedding periods D₁ and D₂ with the predefined customer threshold S_{L}. In the example shown in FIG. 2, the result of this comparison is that: customer 21 is eligible for load-shedding during both periods D₁ and D₂; customer 22 is eligible for load-shedding during period D₂; customer 23 is eligible for load-shedding during period D₁; and customer 24 is not eligible for load shedding.

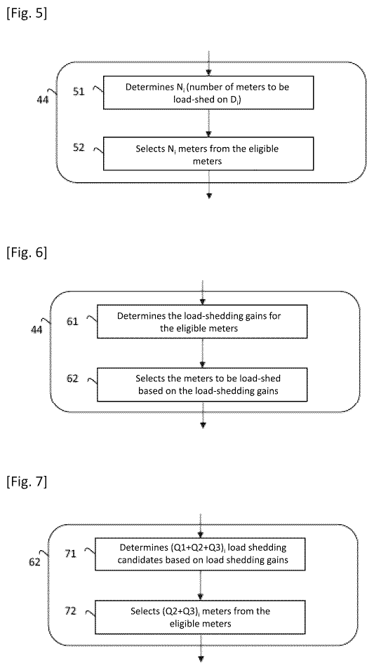

FIG. 5 describes the next step 44 in this first embodiment. As shown in FIG. 5, step 44 is divided into two steps 51 and 52, which are executed for each load-shedding period Dᵢ identified in step 42.

In step 51, the network head 11 determines a number Nᵢ of meters to be load-shed over the period Dᵢ to compensate for the difference Δᵢ between the maximum of the overall forecast consumption Max₁ for each load-shedding period Dᵢ and the predefined overall threshold S_{G}: Δᵢ=Maxᵢ−S_{G}. For example, the number of meters Nᵢ to be load-shed is based on the ratio between the difference to be compensated Δᵢ and the predefined customer threshold S_{L}. For example

$${N}_{i} = INT ( \frac{{Δ}_{i}}{{S}_{L}} ) + 1.$$

Then in step 52, the network head 11 selects Nᵢ meters to be load-shed for the load-shedding period Dᵢ from the meters that have been determined as eligible for load-shedding for the period Dᵢ in step 43. Selection may be random. It may also take into account the customer's subscription type, and/or the number of load-shedding operations carried out in the past for eligible customers, and/or the number of load-shedding periods identified for each eligible customer, etc.

Next, in step 45, the network head sends a load-shedding command to the selected meters for at least one future occurrence of the time range in question (for example day D of one or more subsequent weeks). For example, in the example of FIG. 2, assuming that the meters selected are the meters of customers C₂₁ and C₂₂, the command sent to the meter of customer C₂₁ specifies two load-shedding periods D₁ and D₂ and the command sent to the meter of customer C₂₂ specifies one load-shedding period D₂.

For example, the load-shedding command comprises a start indication T_{d} and an end indication T_{f} (or alternatively a duration indication) for each load-shedding period of the specified time range. For example, this command is transmitted in a DLMS/COSEM data frame as a COSEM object with a load-shedding OBIS code, i.e. a “Limiter” object with the OBIS code shown in the table below:

OBIS code

| Object | IC | A | B | C | D | E | F |
|---|---|---|---|---|---|---|---|
| Limiter | 71, limiter | 0 | b | 17 | 0 | e | 255 |

The data frame comprises a field containing the payload data. This field comprises, for example:
one byte to indicate the number of load-shedding periods applicable to the meter for which the command is intended;
for each load-shedding period, one byte to indicate the hour and one byte to indicate the minute when the load-shedding starts; and one byte to indicate the hour and one byte to indicate the minute when the load-shedding ends.

Advantageously, it is ensured that all meters involved in the same load-shedding period do not start load shedding at exactly the same time, and do not stop load shedding at exactly the same time. This would lead to load changes that would be detrimental to the balance of the distribution network.

In a first example, the commands sent to the various meters contain start indications T_{d} for the same load-shedding period that are offset in time from one another. For example, the meter of the customer C₂₁ receives a command to start load shedding with a start indication at 16:00 and an end indication at 20:00 for the period P₂. Furthermore, the meter of the customer C₂₂ receives a command to start load shedding with a start indication at 16:01, offset by one minute for the same period P₂. If the order contains an end indication, this is shifted by the same amount of time (so in this example, the end indication is equal to 20:01 for the meter of the customer C₂₂).

In another example, the start and end indications T_{d} and Tᵢ are the same for all selected meters. Furthermore, each meter starts and stops load shedding according to a random variable managed by the meter, which implies a start and an end at a random time within an interval around the start T_{d} and end T_{f} indications respectively. For example, each meter starts load shedding randomly in the interval [T_{d}−2′30″; T_{f}+2′30″] and stops doing it randomly in the interval [T_{f}−2′30″; T_{f}+2′30″].

In the second embodiment, during a learning phase, the network head 11 learns the impact of load shedding for each meter. This learning process is independent of load-shedding requirements. It can be done once or regularly, for example every year, once in summer and once in winter. The learning is done on real data. For example, during the learning phase, for each time range considered, a load-shedding command is sent to each meter by time slot, in order to obtain information representative of the customer's consumption in load-shedding mode for each time slot of each time range. For example, when the time range under consideration corresponds to a specific day of the week, a load-shedding command is sent to all meters every 15 minutes for each specific day of the week, in order to learn how meters respond to load-shedding commands. For example, if the time range considered is a day, it can be divided into 96 time slots of 15 minutes each.

FIG. 6 discloses step 44 in this second embodiment. As shown in FIG. 7, step 44 is divided into two steps 61 and 62, which are executed for each load-shedding period Dᵢ identified in step 42. In step 61, the network head 11 determines a load-shedding gain for the meters eligible for load-shedding, by comparing the consumption information transmitted by the meters in non-load-shedding mode with the information learned during the learning phase, which is representative of the customer's consumption in load-shedding mode. In step 62, the network head 11 then selects the meters to be load-shed, based on the load-shedding gains obtained for the meters eligible for load-shedding.

For example, the network head determines a number of meters required to achieve the target gain, from the load-shedding gains of eligible meters taken in order of decreasing load-shedding gain. For example, the network head adds up the load-shedding gains of the meters in descending order until the target gain is achieved, and selects the corresponding meters for load-shedding. This embodiment makes it possible to target those customers for whom load shedding will have the greatest impact.

In another example, the network head determines, based on the load-shedding gains of eligible meters, a number of meters greater than the number of meters required to achieve the target gain, then performs a selection from the meters determined to achieve the target gain. Selection is random, for example, or may take into account various parameters as mentioned hereinbefore. This embodiment makes it possible to target those customers for whom load shedding will have the greatest impact, while avoiding always selecting the same customers.

FIG. 7 discloses an example embodiment of the selection step 62. In this example, step 62 is divided into two steps 71 and 72. In step 71, the network head 11 determines from the eligible meters taken in order of decreasing load-shedding gain, a first, a second, and a third group of meters, comprising Q1, Q2 and Q3 eligible meters respectively, such that the sum of the load-shedding gains of the Q1+Q2 meters in the first and second groups allows the target gain to be achieved, and the sum of the load-shedding gains of the Q2+Q3 meters in the second and third groups allows the target gain to be achieved. In step 72, a selection of Q2+Q3 meters to be load-shed is then made from the Q1+Q2+Q3 meters determined, for example at random. For example, the Q1+Q2 meters of the first and second groups are obtained by adding the load-shedding gains of the meters in descending order until the target gain is achieved. Next, the Q2+Q3 meters of the second and third groups are obtained by adding up the load-shedding gains of the meters in descending order from the start of the second group until the target gain is achieved.

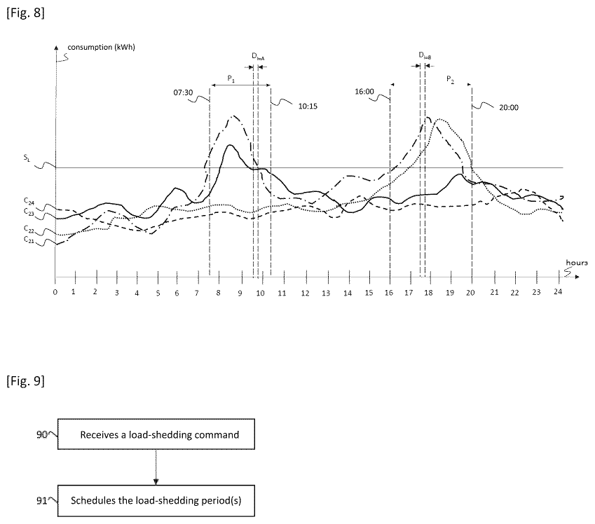

Preferably, the load-shedding periods are synchronized to the time slots used during the learning phase. The easiest way is to use learning time slots and load-shedding periods of the same duration (for example 15 min.). It is also possible to use load-shedding periods whose duration is a multiple of the learning time slots. Thus, in this second embodiment, the periods of overconsumption P₁ et P₂ shown in FIG. 2 and FIG. 3 correspond to one or more periods of load shedding Dᵢ. FIG. 8 depicts the same load curves as FIG. 2, whereupon by way of example, two load-shedding periods are shown corresponding to two learning time slots: a load-shedding period Dᵢ=A which is part of the first overconsumption period P₁ and runs between 09:30 and 09:45, and a load-shedding period Dᵢ=B which is part of the second overconsumption period P₂ and runs between 17:30 and 17:45 (with 0<A<B≤96). FIG. 8 shows that during the load-shedding period Dᵢ=A, only customer C₂₁ is eligible for load shedding. And during the load-shedding period Dᵢ=B, customers C₂₁ and C₂₂ are both eligible.

In this second embodiment, the load-shedding command sent in step 45 comprises an indication of a number of load-shedding periods for the time range concerned as well as an identifier for each of the load-shedding periods. For example, if the time range corresponds to one day, and the load-shedding periods are set at 15 minutes, there are 96 possible load-shedding periods over the day. The order will indicate how many load-shedding periods are planned for the order recipient, and during which of the 96 possible periods the load-shedding will take place. In this embodiment, advantageously, each meter starts and stops load shedding according to a random variable managed by the meter which implies a start and an end at a random time relative to the start and end of the load-shedding period.

For the sake of simplicity, the embodiments described herein relate to load-shedding commands with a single load-shedding level (the command is binary). This is not exhaustive. The embodiments described herein can be easily adapted by a person skilled in the art to allow several levels of load shedding (in the case of customer installations with several load-shedding circuits).

Preferably, to determine the overall forecast consumption and to determine which customers are eligible for load shedding, only information representative of the customer's consumption in non-load-shedding mode is taken into account. For example, if the customer has been subject to load shedding on day D of the current week, the network head 11 uses the information for the last day D that was not subject to load shedding for this customer (instead of using the information transmitted for day D of the current week).

FIG. 9 is a flowchart showing the main steps of a load-shedding method to be implemented by a meter of the distribution network. In step 90, the meter receives the command transmitted by the network head in step 45. In step 91, the meter reads the contents of the command and programs one or more load-shedding operations based on the load-shedding start and end indications contained in the command.

In one embodiment, the meter programs the load shedding(s) so that they are triggered and/or stopped according to a random variable managed by the meter that implies a start and end of load shedding at a random time relative to the start and end of the load-shedding period specified in the load-shedding command.

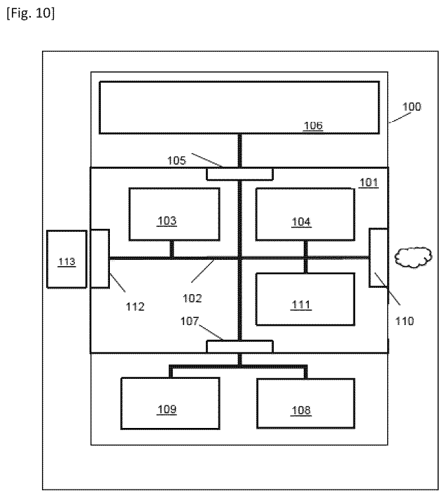

The network head 11 and the meters 13 can for example be implemented in the form of a device as described in FIG. 10. This device referenced 100 comprises a printed circuit board 101 on which a communication bus 102 connects a processor 103, a random access memory 104, a storage medium 111, optionally an interface 105 for connecting a display 106, a series of connectors 107 for connecting user interface devices or modules such as a mouse or trackpad 108 and a keyboard 109, a wireless network interface 110 and/or a wired network interface 112. Depending on the functionality required, in particular whether the device 100 is being used in a network head 11 or a meter 13, the device may implement only some of the foregoing. For example, a meter 13 is not usually connected to a mouse, trackpad or keyboard, nor to a wireless or wired network, as information exchanges with the meter are usually carried out by powerline communication. Some of the modules shown in FIG. 10 may be internal or externally connected, in which case they are not necessarily an integral part of the device itself. For example, the display 106 may be a display that is only connected to the device 100 in specific circumstances, or the device 100 may be controlled by another device with a display, in which case the device 100 has no display 106 or interface 105.

The memory 111 contains one or more software codes which, when executed by the processor 103, enable the network head 11 to perform the load-shedding management method disclosed herein. In one example, a removable storage medium 113, such as a USB key, can also be connected. For example, the detachable storage medium 113 may contain software codes to be downloaded into the memory 111.

The processor 103 can be any type of processor such as a central processing unit (“CPU”) or a dedicated microprocessor such as an integrated microcontroller or digital signal processor (“DSP”).

The device 100 may also comprise other components typically found in computer systems, such as an operating system, queue managers, device drivers, or one or more network protocols that are stored in memory 111 and executed by the processor 103.

The person skilled in the art will understand that all the block diagrams presented here represent conceptual views, given by way of example, of circuits incorporating the principles of the disclosure.

Each function, block, and step described can be implemented in hardware, software, firmware, middleware, microcode or any suitable combination thereof. If implemented in software, the functions or blocks of the block diagrams and flowcharts can be implemented by computer program instructions/software codes, which can be stored or transmitted on a computer-readable medium, or loaded onto a general-purpose computer, special-purpose computer or other programmable processing device and/or system, so that the computer program instructions or software code running on the computer or other programmable processing device create the means for implementing the functions described in this description.

Although aspects of this disclosure have been described with reference to specific achievements, it should be understood that these achievements merely illustrate the principles and applications of this disclosure. It is therefore understood that numerous modifications can be made to the illustrative embodiments and that other arrangements can be devised without departing from the spirit and scope of the disclosure as determined on the basis of the claims and their equivalents.

Advantages and solutions to problems have been described above with regard to specific embodiments of the invention. However, advantages, benefits, solutions to problems, and any element which may cause or result in such advantages, benefits or solutions, or cause such advantages, benefits or solutions to become more pronounced shall not be construed as a critical, required, or essential feature or element of any or all of the claims.

1. A method for managing load shedding in a resource distribution network, the network comprising at least one network head and a plurality of meters configured to:
measure a customer's consumption of said resource,
send the network operator information representative of the customer's consumption,
receive a load-shedding command from the network head and trigger a switch from a non-load-shedding operating mode to a load-shedding operating mode based on said command,
wherein the method comprises steps for:
determining, from information representing customer consumption, an overall forecast consumption over a period of time for all meters,
determining one or more load-shedding periods for said time range, by comparing the overall forecast consumption with a predefined overall threshold,
determining one or more meters eligible for load shedding, for the load-shedding period(s), by comparing information representative of the customer's consumption over the load-shedding period with a predefined customer threshold,
selecting one or more meters to be load-shed from the eligible meters, to obtain a target gain enabling to compensate for a difference between a maximum of the overall forecast consumption over the load-shedding period and the predefined overall threshold,
sending a load-shedding command to the selected meters, said command relating to one or more future occurrences of said time range and specifying one or more load-shedding periods for said time range.

2. The method for managing load shedding according to claim 1, wherein the method comprises a step for determining a load-shedding gain for eligible meters, by comparing information representative of the customer's consumption in non-load-shedding mode, with information, learned during a learning phase, representative of the customer's consumption in load-shedding mode, and in that the selection of meters to be load-shed is based on said load-shedding gains.

3. The method for managing load shedding according to claim 2, wherein during the learning phase, for each time range considered, a load-shedding command is sent to each meter bytime slot, in order to obtain information representative of the customer's consumption in load-shedding mode, for each time slot of each time range, the load-shedding periods being synchronized to said time slots.

4. The method for managing load shedding according to claim 2, wherein the selection of meters to be load-shed comprises:
determining a first number of meters greater than the number of meters required to achieve the target gain, and
a random selection of a second number of meters, less than the first number, to achieve the target gain.

5. The method for managing load shedding according to claim 2, wherein the selection of meters to be load-shed comprises:
determining from the eligible meters taken in order of decreasing load-shedding gain, a first, a second and a third group comprising Q1, Q2 and Q3 eligible meters respectively, the sum of the load-shedding gains of the Q1+Q2 meters of the first and second groups allowing the target gain to be achieved, and the sum of the load-shedding gains of the Q2+Q3 meters of the second and third groups allowing the target gain to be achieved,
selecting from Q1+Q2+Q3 eligible meters of Q2+Q3 meters to be load-shed.

6. The method for managing load shedding according to claim 1, wherein the load-shedding command comprises a number of load-shedding periods for said time range and an identifier for each load-shedding period.

7. The method for managing load shedding according to claim 1, wherein the only information representative of the customer's consumption in non-load-shedding mode is taken into account when determining the overall forecast consumption.

8. The method for managing load shedding according to claim 1, wherein the only information representative of the customer's consumption in non-load-shedding mode is taken into account when determining the meters eligible for load-shedding.

9. A network head device comprising means for implementing a method for managing load shedding in a distribution network according to claim 1.

10. A method for load shedding by a meter belonging to a resource distribution network, the meter being configured to measure a consumption of said resource by a customer and to transmit, to a network head of the distribution network, customer information representative of the customer's consumption over a specified time range, the method comprises a step of receiving a load-shedding command from the network head, the load-shedding command specifying one or more load-shedding periods to be implemented during one or more future occurrences of the specified time range.

11. The method for load shedding according to claim 10, wherein the load-shedding command comprises a number of load-shedding periods for said time range and an identifier for each load-shedding period.

12. The method for load shedding according to claim 10, wherein the load shedding is initiated and/or terminated at a random time relative to the load-shedding periods specified in the load-shedding command.

13. A metering device comprising means for implementing a load-shedding method according to claim 10.

14. A computer program product comprising instructions which when executed by at least one processor cause the implementation of a load-shedding management method according to claim 1.

15. The computer program product comprising instructions which when executed by at least one processor cause the implementation of a load-shedding method according to claim 10.

16. A non-transitory computer-readable storage medium comprising instructions which when executed by a processor cause the implementation of a load-shedding management method according to claim 1.

17. A non-transitory computer-readable storage medium comprising instructions which when executed by a processor cause the implementation of a load-shedding method according to claim 10.
